(19) United States
(12) Patent Application Publication
(10) Pub. No.: US 2019/0195129 A1
(43) Pub. Date: Jun. 27, 2019

(54) FUEL LUBRICATED FOIL BEARING

(71) Applicant: United Technologies Corporation, Farmington, CT (US)

(72) Inventor: Robert J. Morris, Portland, CT (US)

(21) Appl. No.: 15/850,611

(22) Filed: Dec. 21, 2017

(51) Int. Cl. F02C 7/06; F02C 7/236; F16C 17/04; F16C 33/66

(52) U.S. Cl. CPC F02C 7/06; F02C 7/236; F02C 3/04; F16C 33/6659; F16C 33/6681; F16C 17/042

(57) ABSTRACT

A bearing assembly for an engine is disclosed. The bearing assembly includes a first structure, a second structure that is movable relative to the first structure, and a foil membrane disposed between the first structure and the second structure. The foil membrane includes at least one perforation that supplies liquid fuel in a region between the foil membrane and the second structure, where the liquid fuel is combusted by the engine.

### BACKGROUND

Engines, such as those which power aircraft and industrial equipment, may employ a compressor to compress air that is drawn into the engine and a turbine to capture energy associated with the combustion of a fuel-air mixture. Bearings are used in an engine to interface a first (e.g., static) structure and a second (e.g., movable) structure.

Hydrodynamic bearings are well known and have been used effectively as supports for rotating machinery, including high speed applications. The term hydrodynamic bearing, as used herein, defines a class of fluid-film bearings which has its surfaces separated by a thin layer of either liquid or gas, the film being established and the pressure generated therein by the relative motion between the bearing surfaces. This is distinguished from bearings of the hydrostatic type which require a feed of pressurized fluid from an external source. Various embodiments of hydrodynamic bearings are disclosed in the U.S. Pat. No. 4,247,155. The contents of U.S. Pat. No. 4,247,155 are incorporated herein by reference.

In many applications, oil is used as a lubricating fluid for a bearing. An oil system typically includes tanks, pumps, heat exchangers/coolers, deaerators, and other components to support the lubrication of bearings with oil. U.S. patent application publication number 2014/0076661 describes and illustrates various lubrication systems and components that may be used. The contents of U.S. patent application publication number 2014/0076661 are incorporated herein by reference.

The components of an oil lubrication system represent a penalty in terms of, e.g., the complexity/cost that they add to the engine. Additionally, the components serve as a potential source of unreliability of the engine, e.g., one or more of the components may become inoperable. Additionally, the components contribute weight to the engine; this additional weight may lead to inefficiencies in some applications (e.g., aerospace applications).

In some applications, a gas (e.g., air) is used as a lubricating fluid for a bearing. The use of a gas as the lubricating fluid is a cleaner, more environmentally-friendly implementation relative to oil. However, gases have a lower viscosity than oil such that for the same working fluid pressure, gas-lubricated bearings will have a lower/reduced load capacity relative to oil-lubricated bearings. This lower load capacity may make the use of gas-lubricated bearings impractical in some applications.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure are directed to a bearing assembly for an engine, comprising: a first structure, a second structure that is movable relative to the first structure, and a foil membrane disposed between the first structure and the second structure, where the foil membrane includes at least one perforation that supplies liquid fuel in a region between the foil membrane and the second structure, where the liquid fuel is combusted by the engine. In some embodiments, the second structure is rotatable relative to the first structure. In some embodiments, the first structure includes a case of the engine, and the second structure includes a shaft of the engine. In some embodiments, the bearing assembly further comprises a plurality of spring pads coupled to the first structure, where the spring pads are disposed between the first structure and the foil membrane.

Aspects of the disclosure are directed to a system for an engine, comprising: a fuel tank, at least one pump that provides liquid fuel from the fuel tank to a nozzle of a combustion section of the engine, and a bearing assembly that includes a first structure, a second structure that is movable relative to the first structure, and a membrane disposed between the first structure and the second structure, where the membrane includes a plurality of perforations that receive liquid fuel from the at least one pump and supply the received liquid fuel in a region between the membrane and the second structure. In some embodiments, the at least one pump includes a first pump and a second pump. In some embodiments, the first pump provides liquid fuel from the fuel tank to the nozzle, and where the second pump provides liquid fuel from the fuel tank to the bearing assembly. In some embodiments, the bearing assembly receives liquid fuel from the at least one fuel pump via a first channel, and where the bearing assembly returns liquid fuel to at least one of the fuel tank or the at least one pump via a second channel and a filter coupled to the at least one of the fuel tank or the at least one pump. In some embodiments, the at least one pump includes a first pump that supplies liquid fuel to the nozzle and liquid fuel to the bearing assembly. In some embodiments, the system further comprises a first channel that couples the first pump and the nozzle, and a second channel that couples the first pump and the bearing assembly. In some embodiments, the second channel is tapped off of the first channel, and the first channel is connected to the first pump. In some embodiments, the second structure is rotatable relative to the first structure. In some embodiments, the first structure includes a case of the engine, and the second structure includes a shaft of the engine. In some embodiments, the system further comprises a plurality of spring pads coupled to the first structure, where the spring pads are disposed between the first structure and the membrane.

Aspects of the disclosure are directed to an engine comprising: a case, a shaft, an inlet, a compressor section that compresses air received at the inlet, a combustor section that combusts a mixture of compressed air provided by the compressor section and fuel, a turbine section that extracts energy from combusted mixture to drive the compressor section via a rotation of the shaft, where the shaft couples the compressor section and the turbine section, and a bearing assembly that supports the shaft, the bearing assembly including a membrane disposed between the shaft and the case, where the membrane includes at least one perforation that supplies liquid fuel to a region between the membrane and the shaft. In some embodiments, the engine is free of oil. In some embodiments, the combustor section includes at least one fuel nozzle that supplies the liquid fuel included in the mixture. In some embodiments, the engine further comprises a fuel tank, and a fuel pump that receives liquid fuel from the fuel tank and supplies the received liquid fuel to the at least one fuel nozzle and the bearing assembly.

### BRIEF DESCRIPTION OF THE DRAWINGS

The present disclosure is illustrated by way of example and not limited in the accompanying figures in which like reference numerals indicate similar elements. The figures are not necessarily drawn to scale unless explicitly indicated otherwise.

FIG. 1 is a side cutaway illustration of an axial flow turbojet engine.

FIG. 1A is a side cutaway illustration of a centrifugal/radial flow turbojet engine.

FIG. 2 illustrates an axial bearing assembly in accordance with this disclosure.

FIG. 2A illustrates a radial bearing assembly in accordance with this disclosure.

FIGS. 3 and 3A illustrate fuel systems in accordance with this disclosure.

### DETAILED DESCRIPTION

It is noted that various connections are set forth between elements in the following description and in the drawings (the contents of which are included in this disclosure by way of reference). It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities.

In accordance with various aspects of the disclosure, apparatuses, systems, and methods are described for applying a lubricant to one or more bearings of an engine. In some embodiments, the lubricant may include a fuel that is combusted by the engine.

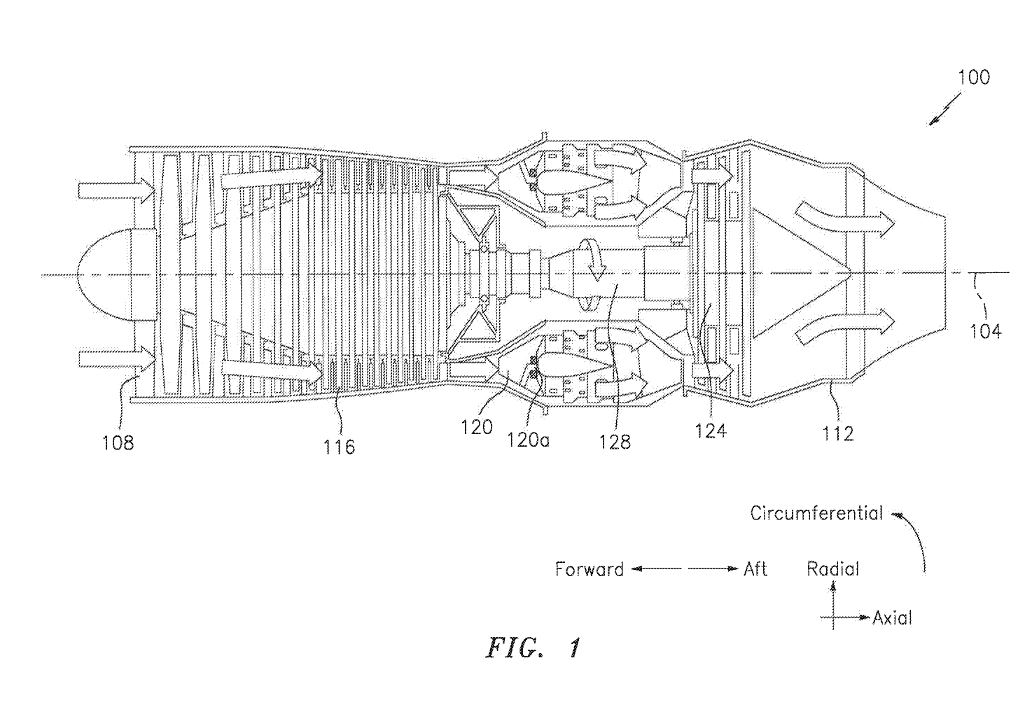

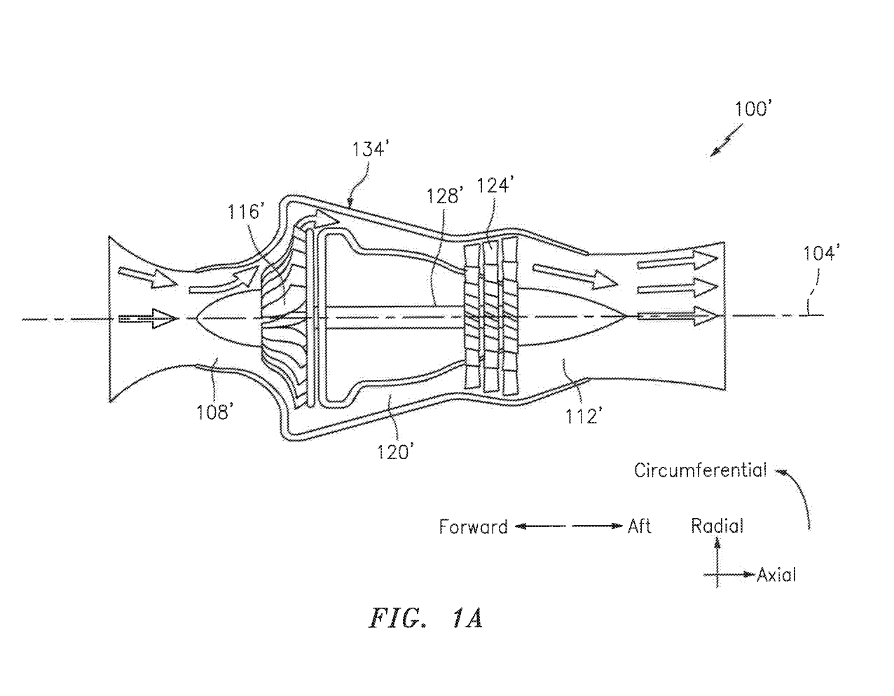

Aspects of the disclosure may be applied in connection with an engine. FIG. 1 is a side cutaway illustration of an axial flow turbojet engine 100. The engine 100 may extend along a longitudinal axial centerline 104 between an upstream/forward airflow inlet 108 and a downstream/aft airflow exhaust nozzle 112. The engine 100 may include a compressor section 116, a combustor section 120, and a turbine section 124.

During operation, air may enter the engine 100 through the inlet 108 where it may be compressed by the compressor section 116. The compressed air may be provided to the combustor section 120. In the combustor section 120, the compressed air may be mixed with fuel provided by one or more fuel nozzles 120a and ignited to power the engine 100. The output of the combustor section 120 may be provided to the turbine section 124. The turbine section 124 may extract energy from the output of the combustor section 120 to drive the compressor section 116 via a rotation of a shaft 128 that couples (e.g., mechanically couples) the compressor section 116 and the turbine section 124. The combusted fuel-air mixture may be exhausted via the nozzle 112.

FIG. 1A is a side cutaway illustration of centrifugal/radial flow turbojet engine 100′. The engine 100′ may include an inlet 108′, a compressor section 116′, a combustor section 120′, a turbine section 124′, and an exhaust nozzle 112′. The engine 100′ (and its associated sections/devices/components) may be similar to the engine 100. The engine 100′ may differ from the engine 100 in that the compressor section 116′ may direct the incoming airflow through the inlet 108′ in a circumferential direction and/or in a radial (outboard) direction (relative to the engine centerline/axis 104′). This airflow may be redirected by, e.g., an engine case 134′ downstream of the compressor section 116′ so as to be more parallel to the axis 104′.

FIGS. 1 and 1A represent possible configurations for an engine. Aspects of the disclosure may be applied in connection with other environments, including additional configurations for engines. For example, aspects of the disclosure may be applied in connection with turbofan engines, turboprops, turboshafts, etc.

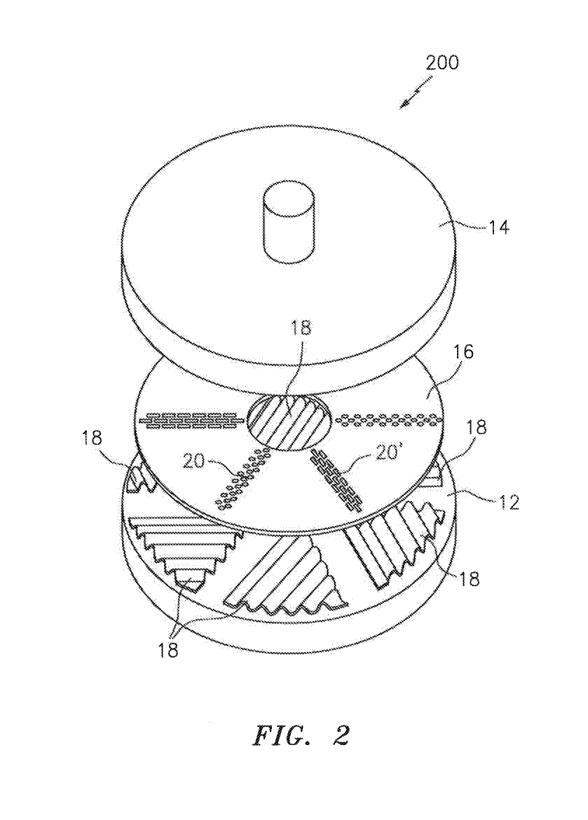

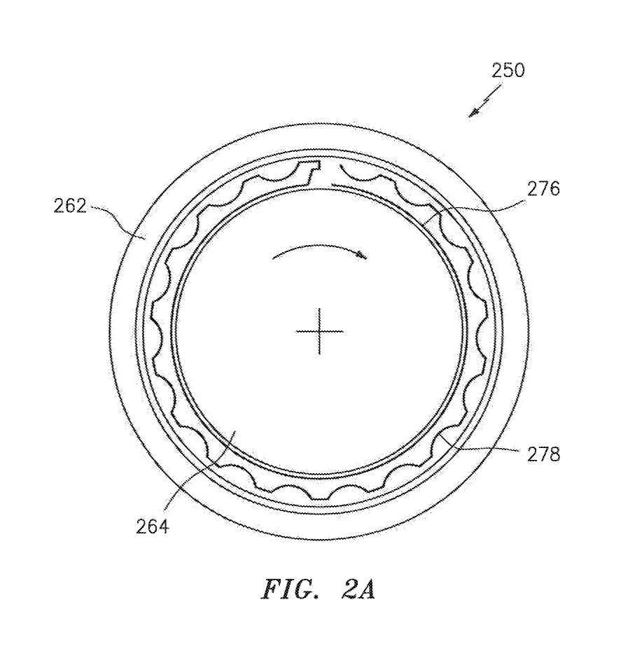

Hardware of an engine may be supported by one or more bearings/bearing assemblies. For example, FIG. 2 illustrates an embodiment of a bearing assembly 200 in accordance with aspects of this disclosure. The bearing assembly 200 may include a first structure 12 and a second structure 14. The second structure 14 may be movable (e.g., rotatable) relative to the first structure 12. The first structure 12 may be a stationary structure. In some embodiments, the first structure 12 may include a housing/case (e.g., the case 134′ of FIG. 1A). In some embodiments, the second structure 14 may include a shaft (e.g., the shaft 128/128′ of FIG. 1/1A).

The bearing assembly 200 may include a compliant foil membrane 16 supported by one or more resilient spring pads 18. The spring pads 18 may be coupled to the first structure 12, such that the spring pads 18 are disposed between the first structure 12 and the foil membrane 16. The foil membrane 16 may include one or more thin, foil-like sheets of metal (or other suitable material) that are compliant, i.e., a sheet of metal whose thickness relative to its lateral dimensions is sufficiently small to allow local bending/deflection.

As shown, the foil membrane 16 may include perforations 20. The perforations 20 may be arrayed in one or more lines as shown in FIG. 2. The perforations 20 may extend across some, or even an entirety of, a dimension of the foil membrane 16. The perforations 20 may accommodate a load during engine operation. For example, the perforations 20 may represent relative weakness in the foil membrane 16 to accommodate a deflection of the second structure 14 relative to the first structure 12 during engine operation.

The perforations 20 may provide a passageway through which fluid may flow uniformly to an area/region between the foil 16 and movable member 14 in order to increase (e.g., maximize) pressure maintenance by efficiently replacing any fluid that may be displaced/circulated. The perforations 20 may be positioned above the space between successive spring pads 18 to enable a deflection of the foil membrane 16 and an unobstructed flow of fluid through the perforations 20. The spring pads 18 may provide the foil membrane 16 with resilient support.

FIG. 2A illustrates a bearing assembly 250 in accordance with aspects of this disclosure. The bearing assembly 250 may include a first structure 262 and a second structure 264. The second structure 264 may be movable (e.g., rotatable) relative to the first structure 262. The first structure 262 may be a stationary structure. In some embodiments, the first structure 262 may include a housing/case (e.g., a bearing housing). In some embodiments, the second structure 264 may include a shaft/journal.

Disposed between the first structure 262 and the second structure 264 may be a foil structure/membrane. In particular, the foil membrane may include a first (e.g., top) foil 276 and a second foil 278. The second foil 278, which may be referred to as a bump foil, may provide a compliant support structure for the bearing assembly 250. For example, the second foil 278 may accommodate a deflection of the second structure 264 relative to the first structure 262. The foil membrane may provide fluid (e.g., liquid fuel) in an area/region between the foil membrane and the second structure 264 via, e.g., one or more perforations (e.g., perforations 20 of FIG. 2).

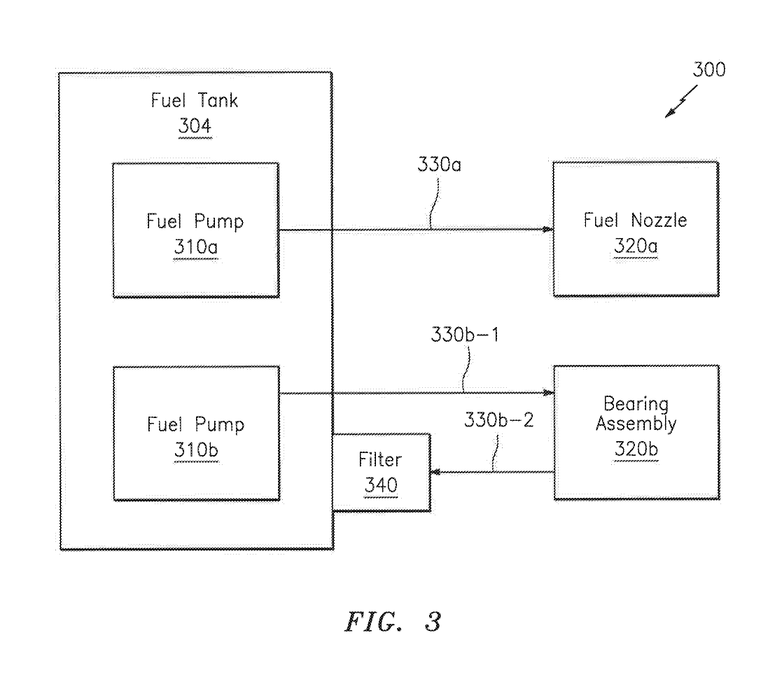

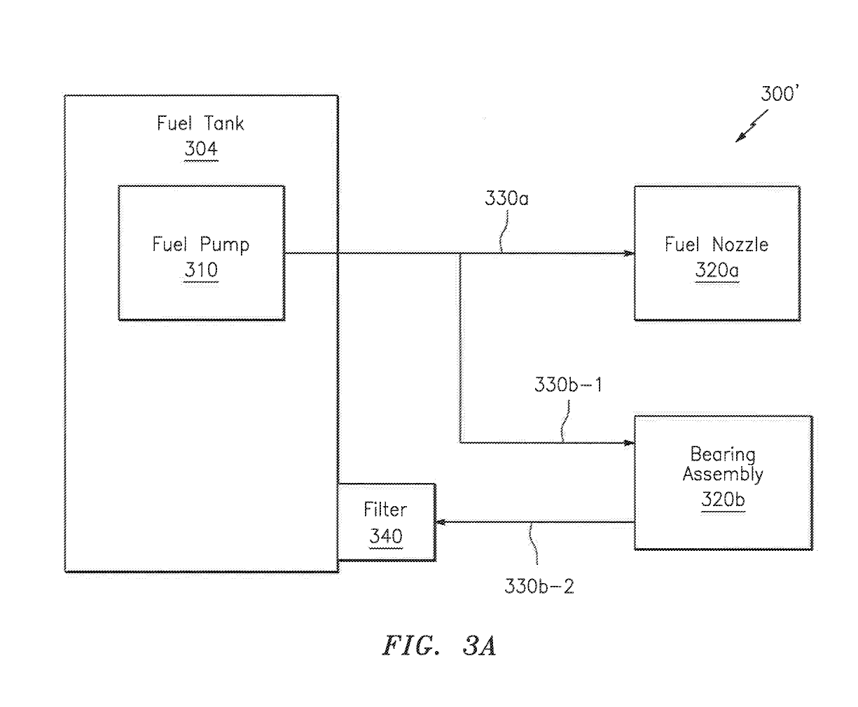

Referring to FIG. 3, a fuel system 300 is shown. The system 300 may include a fuel tank 304. The fuel tank 304 may serve as a reservoir/storage of fuel (e.g., liquid fuel). The fuel tank may include one or more fuel pumps, such as for example a first fuel pump 310a and a second fuel pump 310b. While the fuel pumps 310a and 310b are shown as being included in the fuel tank 304, one or both of the pumps 310a and 310b may be separate components (relative to the fuel tank 304) in some embodiments.

The first fuel pump 310a may provide fuel to one or more fuel nozzles, such as for example a fuel nozzle 320a, via one or more fuel pipes/channels 330a. The fuel nozzle 320a may correspond to the fuel nozzle 120a of FIG. 1. The fuel nozzle 320a, which may be included in a combustor section of an engine (e.g., combustor section 120/120′ of FIG. 1/1A), may provide fuel that it receives from the first fuel pump 310a for purposes of combustion.

The second fuel pump 310b may provide fuel to a bearing assembly 320b via one or more fuel channels 330b-1. The bearing assembly 320b may correspond to the bearing assembly 200 of FIG. 2 or the bearing assembly 250 of FIG. 2A. The fuel provided by the fuel pump 310b to the bearing assembly 320b via the channel 330b-1 may be used to form a film of fuel between two or more components of the bearing assembly 320b (e.g., between the foil membrane 16 and the second structure 14 of FIG. 2; in FIG. 2A between one or both of the first foil 276 and the second foil 278 on the one hand and the second structure 264 on the other hand). A closed loop/circuit may be formed between the fuel tank 304 and the bearing assembly 320b, such that the fuel that is supplied via the channel 330b-1 may be returned to the fuel tank 304 and/or the second fuel pump 310b via a return channel 330b-2. One or more filters 340 may be included to filter the fuel that is conveyed via the return channel 330b-2 prior to (re)introducing the fuel to, e.g., the fuel tank 304.

As shown in FIG. 3, the system 300 may provide separate channels/lanes in terms of fuel used by the fuel nozzle 320a relative to fuel used by the bearing assembly 320b. Such separation may be useful for purposes of reliability, maintenance (e.g., trouble-shooting), etc., due to the segregation/isolation that is obtained.

FIG. 3A illustrates an embodiment of a system 300′ that at least partially combines the lanes. For example, the channels 330a and 330b-1 may be combined in the system 300′. For example, in the system 300′ fuel provided to the bearing assembly 320b via the channel 330b-1 may be obtained from the channel 330a (e.g., the channel 330b-1 may be tapped from the channel 330a, and the channel 330a may be connected to a fuel pump 310). Whereas FIG. 3 illustrates the use of two fuel pumps 310a and 310b, in FIG. 3A a single fuel pump 310 may be used. Relative to the system 300, the system 300′ may be lighter (e.g., may weigh less) due to the inclusion of less fuel pumps and/or a sharing of lane/channel resources.

The system 300 and/or the system 300′ may be included as part of an engine (e.g., the engine 100/100′ of FIG. 1/1A).

Aspects of the disclosure may utilize fuel (e.g., liquid fuel) as a lubricating fluid for a bearing (e.g., a foil bearing). The use of fuel as the lubricating fluid may reduce (or even completely eliminate) components that are used in a conventional lubrication system (e.g., a conventional oil lubrication system). For example, in some embodiments an engine might not include oil; e.g., the engine may be free of oil. Furthermore, the use of fuel as a lubricating fluid may leverage existing hardware (e.g., fuel pumps, fuel tanks, fuel channels, etc.), thereby promoting efficiency (e.g., reducing weight). The use of fuel as a lubricating fluid may increase a load capacity relative to the use of, e.g., air as a lubricating fluid, thereby enabling a larger load (e.g., larger engine hardware) to be accommodated/supported.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional in accordance with aspects of the disclosure. One or more features described in connection with a first embodiment may be combined with one or more features of one or more additional embodiments.

What is claimed is:

1. A bearing assembly for an engine, comprising:
a first structure;
a second structure that is movable relative to the first structure; and
a foil membrane disposed between the first structure and the second structure, wherein the foil membrane includes at least one perforation that supplies liquid fuel in a region between the foil membrane and the second structure,
wherein the liquid fuel is combusted by the engine.

2. The bearing assembly of claim 1, wherein the second structure is rotatable relative to the first structure.

3. The bearing assembly of claim 1, wherein the first structure includes a case of the engine, and wherein the second structure includes a shaft of the engine.

4. The bearing assembly of claim 1, further comprising:
a plurality of spring pads coupled to the first structure, wherein the spring pads are disposed between the first structure and the foil membrane.

5. A system for an engine, comprising:
a fuel tank;
at least one pump that provides liquid fuel from the fuel tank to a nozzle of a combustion section of the engine; and
a bearing assembly that includes
a first structure;
a second structure that is movable relative to the first structure; and
a membrane disposed between the first structure and the second structure, wherein the membrane includes a plurality of perforations that receive liquid fuel from the at least one pump and supply the received liquid fuel in a region between the membrane and the second structure.

6. The system of claim 5, wherein the at least one pump includes a first pump and a second pump.

7. The system of claim 6, wherein the first pump provides liquid fuel from the fuel tank to the nozzle, and wherein the second pump provides liquid fuel from the fuel tank to the bearing assembly.

8. The system of claim 5, wherein the bearing assembly receives liquid fuel from the at least one fuel pump via a first channel, and wherein the bearing assembly returns liquid fuel to at least one of the fuel tank or the at least one pump via a second channel and a filter coupled to the at least one of the fuel tank or the at least one pump.

9. The system of claim 5, wherein the at least one pump includes a first pump that supplies liquid fuel to the nozzle and liquid fuel to the bearing assembly.

10. The system of claim 9, further comprising:
a first channel that couples the first pump and the nozzle; and
a second channel that couples the first pump and the bearing assembly.

11. The system of claim 10, wherein the second channel is tapped off of the first channel, and wherein the first channel is connected to the first pump.

12. The system of claim 5, wherein the second structure is rotatable relative to the first structure.

14. The system of claim 5, wherein the first structure includes a case of the engine, and wherein the second structure includes a shaft of the engine.

15. The system of claim 5, further comprising:
a plurality of spring pads coupled to the first structure, wherein the spring pads are disposed between the first structure and the membrane.

16. An engine comprising:
a case;
a shaft;
an inlet;
a compressor section that compresses air received at the inlet;
a combustor section that combusts a mixture of compressed air provided by the compressor section and fuel;
a turbine section that extracts energy from combusted mixture to drive the compressor section via a rotation of the shaft, where the shaft couples the compressor section and the turbine section; and
a bearing assembly that supports the shaft, the bearing assembly including a membrane disposed between the shaft and the case, wherein the membrane includes at least one perforation that supplies liquid fuel to a region between the membrane and the shaft.

17. The engine of claim 16, wherein the engine is free of oil.

18. The engine of claim 16, wherein the combustor section includes at least one fuel nozzle that supplies the liquid fuel included in the mixture.

19. The engine of claim 18, further comprising:
a fuel tank; and
a fuel pump that receives liquid fuel from the fuel tank and supplies the received liquid fuel to the at least one fuel nozzle and the bearing assembly.
